(19) United States
(12) Patent Application Publication
(10) Pub. No.: US 2026/0005247 A1
(43) Pub. Date: Jan. 1, 2026

(54) METAL STORAGE HOST BASED ON CARBONIZED MATERIAL CONTAINING TRANSITION METAL AND SECONDARY METAL BATTERY COMPRISING THE SAME

(71) Applicant: UIF (UNIVERSITY INDUSTRY FOUNDATION), YONSEI UNIVERSITY, Seoul (KR)

(72) Inventors: Sang-Young LEE, Seoul (KR); Cheol HEO, Seoul (KR); Seung-Hyeok KIM, Seoul (KR)

(73) Assignee: UIF (UNIVERSITY INDUSTRY FOUNDATION), YONSEI UNIVERSITY, Seoul (KR)

(21) Appl. No.: 19/248,799

(22) Filed: Jun. 25, 2025

(30) Foreign Application Priority Data
Jun. 26, 2024 (KR) 10-2024-0083412
Jun. 24, 2025 (KR) 10-2025-0083475

(51) Int. Cl. H01M 4/587; H01M 4/02; H01M 4/04; H01M 4/62

(52) U.S. Cl. CPC H01M 4/587; H01M 4/0404; H01M 4/045; H01M 4/0471; H01M 4/622; H01M 4/625; H01M 2004/024

(57) ABSTRACT

The present invention relates to a metal storage host comprising: a three-dimensional structure including a carbonized material; and a transition metal distributed on the three-dimensional structure in a single-atom state, a cluster state of atoms, or a mixed state of the single-atom state and the atom cluster state; and a secondary metal battery including the same. Accordingly, the metal storage host of the present invention includes a carbonized material in which a transition metal is distributed in a single-atom state, a cluster state of atoms, or a mixed state of the single-atom state and the atom cluster state. Based on this structure, an anode of a secondary metal battery can be manufactured, thereby securing electrodeposition stability of the metal and suppressing dendritic growth of the metal. As a result, a secondary metal battery with high energy density and long cycle life characteristics can be achieved.

### CROSS-REFERENCE TO RELATED APPLICATION

This application claims priority to Korean Patent Application No. 10-2024-0083412 filed on Jun. 26, 2024 and Korean Patent Application No. 10-2025-0083475 filed on Jun. 24, 2025 and all the benefits accruing therefrom under 35 U.S.C. § 119, the contents of which are incorporated by reference in their entirety.

### BACKGROUND

Currently, among various types of secondary batteries that are commercialized and widely used in various fields, lithium secondary batteries exhibit high energy density and excellent output characteristics. Recently, along with the explosive growth of the electric vehicle market, efforts have been continuously made to increase the energy density of lithium secondary batteries in order to extend the driving distance per charge. However, the anode of currently used lithium secondary batteries is composed of graphite, which has a low theoretical capacity (372 mAh/g), and thus there is a limitation in increasing the energy density of the battery.

Subsequently, by using metals such as Li, Zn, and Mg, which have a theoretical capacity more than 10 times higher than that of graphite, as anodes, it became possible to increase the energy density. However, metal electrodes exhibit dendrite growth due to the non-uniform current distribution on the electrode surface during charge/discharge processes, which causes problems such as volume change of the electrode, continuous reaction with the electrolyte, and generation of electrochemically inactive metal, thereby accelerating the degradation of reversible capacity.

In order to solve the problem of metal dendrite growth in such metal anodes, research on metal storage hosts has been continuously conducted. The metal storage host studies reported so far have modified the current collector using carbon-based materials or alloying-based metal materials that are electrochemically inactive, and then fabricated metal anodes by methods such as electrochemical deposition, rolling, or injection of molten lithium metal. These methods can effectively suppress the dendrite growth of the metal anode by reducing the overpotential required for nucleation and growth of the electrodeposited metal, thereby significantly improving the lifespan characteristics of the metal electrode.

However, metal anodes including such metal storage hosts are thick and heavy, and therefore fail to meet the standard values targeting energy density per volume and weight at the cell level. Moreover, since most metal storage hosts are electrochemically inactive, there is a limitation in improving energy density, and in the case of using alloy-based materials, there is a problem of exhibiting low lifespan characteristics due to severe volume change. In addition, studies have been conducted on using graphite or general carbide-based materials as electrodes that also serve as metal hosts. However, such electrode-cum-metal hosts exhibit limitations of low stability and lifespan characteristics due to the issue of metal growing in the form of dendrites, caused by low metal-graphite (or carbide material) interfacial stability and low diffusion coefficients.

### SUMMARY

An object of the present invention is to solve the above-mentioned problems, and to provide a metal storage host and a secondary metal battery including the same, which can contribute to actual capacity realization and simultaneously induce stable metal electrodeposition, and, by having high interfacial stability and a high diffusion coefficient of metal, unlike conventional carbon-based anodes, can enable uniform metal growth without dendritic growth of metal, thereby achieving excellent lifespan characteristics and high energy density per weight and volume.

The objects of the present invention are not limited to the purposes mentioned above, and other objects and advantages of the present invention which are not mentioned will be understood from the following description and will be more clearly understood by the embodiments of the present invention. In addition, it will be easily understood that the objects and advantages of the present invention can be realized by the means and combinations thereof described in the specification.

According to one aspect of the present invention, there is provided a metal storage host comprising: a three-dimensional structure including a carbonized material; and a transition metal that is distributed on the three-dimensional structure in a single-atom state, a cluster state of atoms, or a mixed distribution of the single-atom state and the atom cluster state.

The carbonized material may be a result of carbonization of cellulose.

The transition metal may be at least one selected from the group consisting of copper (Cu), zinc (Zn), nickel (Ni), cobalt (Co), iron (Fe), manganese (Mn), chromium (Cr), vanadium (V), titanium (Ti), scandium (Sc), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

According to another aspect of the present invention, there is provided an anode of a secondary metal battery including the metal storage host.

A metal, which is an anode active material, may be further electro-deposited on the metal host.

The metal, which is the anode active material, may be any one selected from the group consisting of lithium (Li), sodium (Na), potassium (K), zinc (Zn), magnesium (Mg), and aluminum (Al).

According to still another aspect of the present invention, there is provided a method for manufacturing a metal storage host, the method comprising:
(a) preparing a transition metal ion solution by introducing a transition metal salt into a strong base aqueous solution;
(b) preparing cellulose coordinated with the transition metal ions by introducing cellulose into the transition metal ion solution and allowing it to react;
(c) preparing a carbonized material including a transition metal distributed in a single-atom state, a cluster state of atoms, or a mixed state of the single-atom state and the atom cluster state, by carbonizing the cellulose coordinated with the transition metal ions;
(d) preparing an electrode host slurry by mixing the carbonized material containing the transition metal, a conductive material, and a binder; and
(e) coating the electrode host slurry on a current collector.

The metal storage host may also be used as an anode for a metal battery.

A step of electrochemically electrodepositing a metal, which is an anode active material of a secondary metal battery, on the metal storage host may be additionally performed. In step (a), the transition metal salt may be a sulfate or nitrate of a transition metal.

In step (b), the cellulose may be at least one selected from the group consisting of cellulose nanofibers (CNF) and cellulose nanocrystal (CNC).

The cellulose nanofibers may have a diameter of 1 nm to 100 μm and a length of 50 nm to 500 μm, and the cellulose nanocrystal may have a diameter of 1 nm to 100 μm.

In step (c), the carbonization may be performed at a temperature of 300 to 1000° C.

The carbonization may be performed by carrying out a first carbonization at 300 to 600° C., and then performing a second carbonization at 700 to 1000° C.

In step (c), the carbonization may be performed under an inert gas atmosphere.

In step (d), the conductive material may be any one selected from the group consisting of particulate carbon-based conductive materials, fibrous carbon-based conductive materials, plate-shaped carbon-based conductive materials, metal fibers, metal powders, and conductive metal oxides.

The particulate carbon-based conductive material may be any one selected from the group consisting of acetylene black, Ketjen black, channel black, furnace black, lamp black, thermal black, and carbon black, the fibrous carbon-based conductive material may be any one selected from the group consisting of carbon nanotubes and conductive carbon fibers, and the plate-shaped carbon-based conductive material may be graphene.

In step (d), the binder may include at least one selected from the group consisting of carboxymethyl cellulose (CMC) and styrene-butadiene rubber (SBR).

In step (d), the electrode slurry may include 0.5 to 1 part by weight of the conductive material and 3 to 5 parts by weight of the binder, based on 100 parts by weight of the carbonized material containing the transition metal.

In step (e), the coating may be performed by any one selected from the group consisting of slurry casting, spray coating, filtration process, dry process, sputtering coating, electroless plating, electrostatic spraying (E-spraying), vapor deposition, inkjet printing, imprint lithography, offset printing, and 3D printing.

According to still another aspect of the present invention, there is provided a secondary metal battery including the metal storage host.

The secondary metal battery may be any one selected from the group consisting of an alkali metal-metal battery, an alkali metal-air battery, and an alkali metal-sulfur battery.

The alkali metal-metal battery may be any one selected from the group consisting of a lithium metal battery, a sodium metal battery, and a potassium metal battery.

The metal storage host may be one on which a metal, serving as an anode active material of a secondary metal battery, is electrodeposited by an electrochemical method.

According to still another aspect of the present invention, there is provided a device which is any one selected from the group consisting of a portable electronic device, a moving unit, a power device, and an energy storage device, the device including the secondary metal battery.

According to still another aspect of the present invention, there is provided a secondary metal battery including the metal storage host.

The metal storage host may be one on which a metal, serving as an anode active material of a secondary metal battery, is electrodeposited by an electrochemical method.

According to still another aspect of the present invention, there is provided a device which is any one selected from the group consisting of a portable electronic device, a moving unit, a power device, and an energy storage device, the device including the secondary metal battery.

The means for solving the above-mentioned problem do not enumerate all features of the present invention and may be combined with certain embodiments described in this specification. Various features of the present invention, as well as advantages and effects thereof, will be more clearly understood with reference to the following detailed description.

The metal storage host of the present invention includes a carbonized material in which a transition metal is distributed in a single-atom state, a cluster state of atoms, or a mixed state of the single-atom state and the atom cluster state, and by using this as a basis to fabricate an anode for a secondary metal battery, electrodeposition stability of the metal can be secured, and dendritic growth of the metal can be suppressed, thereby enabling the manufacture of a secondary metal battery having high energy density and excellent lifespan characteristics.

In addition to the above-mentioned effects, the specific effects of the present invention will be described together with the detailed description for carrying out the invention provided below. Furthermore, the effects of the present invention are not limited to those mentioned above, and can be easily realized by the means and combinations thereof described in the specification.

### BRIEF DESCRIPTION OF THE DRAWINGS

FIG. 1A is a conceptual diagram of a carbonized material including a transition metal according to the present invention.

FIG. 1B is a conceptual diagram of a carbonized material including a transition metal in a single-atom state according to the present invention.

FIG. 1C is a conceptual diagram of a carbonized material including a transition metal in an atom cluster state according to the present invention.

FIG. 2A is a process diagram showing a manufacturing process of a carbonized material including copper (Cu).

FIG. 2B shows a TEM image of the carbonized material including copper (Cu).

FIG. 3 is a SEM image showing lithium metal electrodeposited on an anode surface according to Experimental Example 1.

FIG. 4 shows charge/discharge profile analysis results according to Experimental Example 2.

FIG. 5 shows XPS analysis results according to Experimental Example 3.

FIG. 6 shows cycle performance evaluation results in a half-cell according to Experimental Example 4.

FIG. 7 shows cycle performance evaluation results in a full cell according to Experimental Example 5.

FIG. 8 shows rate capability evaluation results in a full cell according to Experimental Example 6.

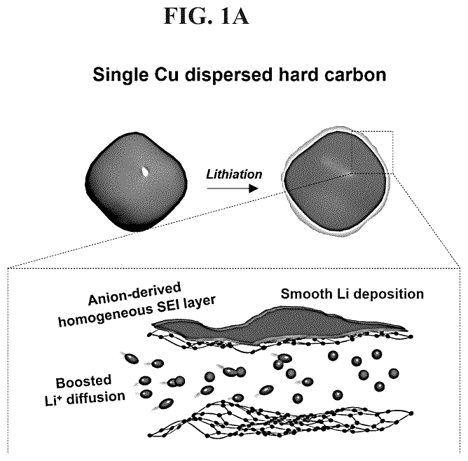

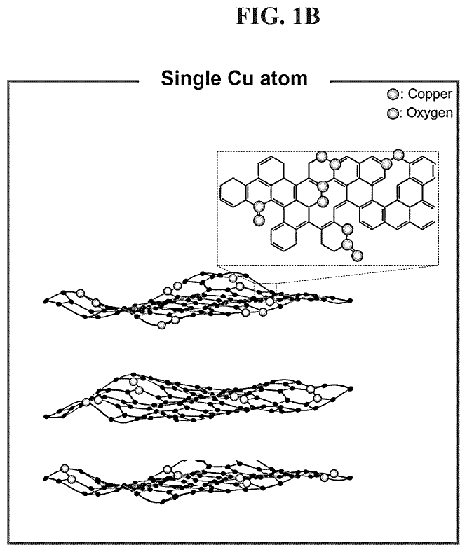

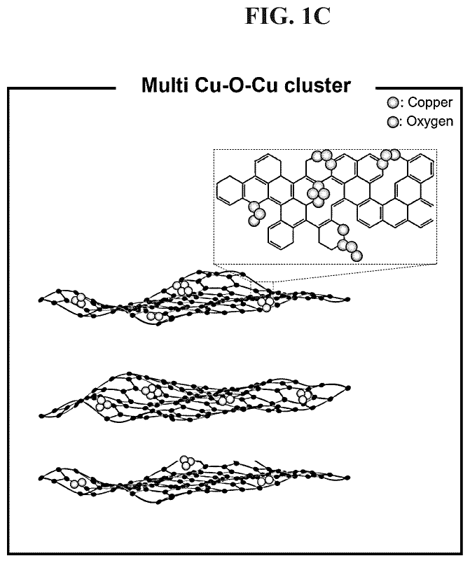

### DETAILED DESCRIPTION OF EMBODIMENTS

Hereinafter, embodiments of the present invention will be described in detail with reference to the accompanying drawings so that those skilled in the art to which the present invention pertains can easily carry out the invention.

However, the following description is not intended to limit the present invention to specific embodiments, and in the course of describing the present invention, detailed descriptions of well-known related technologies may be omitted when it is determined that such descriptions could obscure the gist of the present invention.

The terminology used herein is intended only to describe particular embodiments and is not intended to limit the present invention. Unless clearly stated otherwise in the context, the singular expressions include plural expressions. In the present application, terms such as “include” or “have” are intended to specify the presence of stated features, numerals, steps, operations, elements, or combinations thereof, but should be understood as not precluding the presence or addition of one or more other features, numerals, steps, operations, elements, or combinations thereof.

The metal storage host of the present invention includes: a three-dimensional structure including a carbonized material; and a transition metal distributed on the three-dimensional structure in a single-atom state, a cluster state of atoms, or a mixed state of the single-atom state and the atom cluster state.

According to one embodiment of the present invention, the carbonized material is preferably a product resulting from the carbonization of cellulose.

Cellulose is the most abundant organic polymer on Earth and exists as a main component of materials such as nutshells, fruit peels, and wood. When such biomass is used as a source of hard carbon, which serves as an anode active material in secondary batteries such as lithium secondary batteries, it becomes possible to reduce cost and stably maintain the supply of raw materials. In particular, cellulose retains a relatively high content of heteroatoms such as oxygen even after carbonization, and thus has the advantage of improving electrochemical performance through additional interactions with electrolyte components when used as an active material.

According to another embodiment of the present invention, the transition metal may be at least one selected from the group consisting of copper (Cu), zinc (Zn), nickel (Ni), cobalt (Co), iron (Fe), manganese (Mn), chromium (Cr), vanadium (V), titanium (Ti), scandium (Sc), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

Preferably, the transition metal may be copper (Cu). Copper has advantages of high electrical conductivity and excellent corrosion resistance.

A high diffusion coefficient of a metal such as lithium in the anode active material is essential for stable and uniform metal electrodeposition. A carbonized material in which a transition metal such as copper is uniformly distributed and embedded between cellulose structures in a single-atom state, a cluster state of atoms, or a mixed state of the single-atom state and the atom cluster state, may have an expanded interlayer distance of the graphitic layer of hard carbon compared to carbonized cellulose that does not contain a transition metal, thereby exhibiting a higher metal diffusion coefficient.

In addition, the carbonized material including a transition metal of the present invention may act as a catalyst that induces selective reductive decomposition of anions derived from the salt in the electrolyte.

Through this, a stable solid electrolyte interphase (SEI) can be formed, and the diffusion rate of metal ions such as lithium ions can be improved, thereby enabling stable electrodeposition and stripping of the metal.

In the present invention, the single-atom state refers to a state in which a transition metal exists individually at the atomic level, and the cluster state refers to a state in which 2 to 5 atoms are aggregated together. In the present invention, both the single-atom state and the cluster state may refer to states in which a very small number of atoms are present in a separated manner.

According to another embodiment of the present invention, the secondary metal battery may be an alkali metal-metal battery, an alkali metal-air battery, or an alkali metal-sulfur battery, and preferably, the alkali metal-metal battery may be any one selected from the group consisting of a lithium metal battery, a sodium metal battery, and a potassium metal battery, and more preferably, it may be a lithium metal battery.

In addition, the present invention provides an anode of a secondary metal battery including the metal storage host.

According to one embodiment of the present invention, the anode of the secondary metal battery may be one on which a metal, serving as an anode active material, is additionally electrodeposited on the metal storage host.

The carbonized material including a transition metal distributed in a single-atom state, a cluster state of atoms, or a mixed state of the single-atom state and the atom cluster state, according to the present invention, exhibits an oxidation/reduction reaction voltage range that falls within the usable range for electrode materials in secondary batteries, and shows excellent reversibility, thereby contributing to additional capacity expression in the cell, unlike conventional electrochemically inactive metal storage hosts. In particular, the hard carbon, which is the carbonized material including a transition metal distributed in a single-atom state, a cluster state of atoms, or a mixed state thereof, according to the present invention, can help suppress dendritic growth of deposited metal while storing metal ions, thereby enhancing the reversibility of the electrodeposited metal.

According to another embodiment of the present invention, the metal, which is electrodeposited as the anode active material, may be any one selected from the group consisting of lithium (Li), sodium (Na), potassium (K), zinc (Zn), magnesium (Mg), and aluminum (Al), and preferably, may be lithium (Li) applied to a lithium metal battery.

In addition, the present invention provides a method for manufacturing a metal storage host. First, a transition metal salt is introduced into a strong base aqueous solution to prepare a transition metal ion solution (step a).

The transition metal salt may be a sulfate or nitrate of a transition metal, and preferably, may be a sulfate of a transition metal.

The strong base aqueous solution may be sodium hydroxide, potassium hydroxide, magnesium hydroxide, or the like, and preferably, may be sodium hydroxide.

Subsequently, cellulose is introduced into the transition metal ion solution and reacted to prepare cellulose coordinated with the transition metal ions (step b).

The cellulose is preferably at least one selected from the group consisting of cellulose nanofibers (CNF) and cellulose nanocrystal (CNC).

The cellulose nanofibers may have a diameter of 1 nm to 100 μm and a length of 50 nm to 500 μm. Preferably, the diameter may be 5 to 100 nm, and more preferably, 10 to 50 nm. In addition, preferably, the length of the cellulose nanofibers may be 1 to 300 μm, and more preferably, 10 to 100 μm.

In addition, the cellulose nanocrystals may have a diameter of 1 nm to 100 μm, preferably 5 to 100 nm, and more preferably 10 to 50 nm.

The cellulose is preferably introduced in the form of a dispersion.

Next, the cellulose coordinated with the transition metal ions is carbonized to prepare a carbonized material including a transition metal distributed in a single-atom state, a cluster state of atoms, or a mixed state of the single-atom state and the atom cluster state (step c).

The carbonization is preferably performed at 300 to 1000° C., more preferably by carrying out a first carbonization at 300 to 600° C. followed by a second carbonization at 700 to 1000° C., and even more preferably by carrying out the first carbonization at 350 to 450° C. followed by the second carbonization at 750 to 850° C.

When carbonization is performed under such conditions, the precursor material having coordination bonds formed may efficiently result in copper atoms-distributed in a single-atom state, a cluster state of atoms, or a mixed state of the single-atom state and the atom cluster state-being uniformly distributed within the graphitic layer structure of the carbonized cellulose, i.e., hard carbon.

The carbonization is preferably performed under an inert gas atmosphere.

Next, the carbonized material containing the transition metal, a conductive material, and a binder are mixed to prepare an electrode host slurry (step d).

The conductive material may include particulate carbon-based conductive materials, fibrous carbon-based conductive materials, plate-shaped carbon-based conductive materials, metal fibers, metal powders, and conductive metal oxides. The particulate carbon-based conductive material may be any one selected from the group consisting of acetylene black, Ketjen black, channel black, furnace black, lamp black, thermal black, and carbon black. The fibrous carbon-based conductive material may be any one selected from the group consisting of carbon nanotubes and conductive carbon fibers. The plate-shaped carbon-based conductive material may be graphene. The conductive material is not limited to the above examples, and any conductive material conventionally applicable to the cathodes of lithium-ion batteries may be used.

The binder may be at least one selected from the group consisting of carboxymethyl cellulose (CMC) and styrene-butadiene rubber (SBR). The electrode slurry may include 0.5 to 1 part by weight of the conductive material and 3 to 5 parts by weight of the binder, based on 100 parts by weight of the carbonized material containing the transition metal.

Subsequently, the electrode host slurry is coated on a current collector (step e).

The coating may be performed by any one selected from the group consisting of slurry casting, spray coating, filtration process, dry process, sputtering coating, electroless plating, electrostatic spraying (E-spraying), vapor deposition, inkjet printing, imprint lithography, offset printing, and 3D printing.

The metal storage host may also be used as an anode for a metal battery.

The metal battery anode may be manufactured by additionally performing a step of electrochemically electrodepositing a metal, which serves as an anode active material of a secondary metal battery, on the metal storage host.

The present invention provides a secondary metal battery including the metal storage host. The secondary metal battery of the present invention may include an anode comprising the metal storage host, a cathode, an electrolyte, and a separator. The metal storage host may be one on which a metal, serving as an anode active material of a secondary metal battery, is electrodeposited by an electrochemical method. In the secondary metal battery of the present invention, taking a lithium metal battery as an example, a lithiation reaction of lithium ions and plating of lithium metal may occur sequentially during charging, and during discharging, stripping of lithium metal may be followed by delithiation. Based on such electrochemical reactions, storage of lithium ions and lithium metal can be achieved, thereby exhibiting high energy density and long cycle life characteristics.

n addition, the metal storage host of the present invention can induce uniform nucleation and growth of lithium, enabling stable electrodeposition and use of lithium metal. Furthermore, an SEI layer rich in inorganic components is formed on the surface of the metal storage host of the present invention, thereby stabilizing the interface and simultaneously activating lithium diffusion into the active material. As a result, even during repeated charge/discharge cycles, dendrite formation and volume changes of lithium metal do not occur, and high coulombic efficiency can be achieved.

The active material may be any of various cathode active materials used in lithium-ion battery cathodes.

Various materials may be applied to the cathode, and in the case of a lithium metal battery, the cathode active material may include any one selected from the group consisting of:
LiₓMn_{1-y}M_{y}A₂, LiₓMn₂O_{4-z}X_{z}, LiₓMn_{2-y}M_{y}M′_{z}A₄, LiₓCo_{1-y}M_{y}A₂, LiₓCo_{1-y}M_{y}O_{2-z}X_{z}, LiₓNi_{1-y}M_{y}O_{2-z}X_{z}, LiₓNi_{1-y}Co_{y}O_{2-z}X_{z}, LiₓNi_{1-y-z}Co_{y}M_{z}A_{α}, LiₓNi_{1-y-z}Co_{y}M_{z}O_{2-α}X_{α}, LiₓNi_{1-y-z}Mn_{y}M_{z}A_{α}, and LiₓNi_{1-y-z}Mn_{y}M_{z}O_{2-α}X_{α}.

Here, x is 0.9≤x≤1.1, y is 0≤y≤0.5, z is 0≤z≤0.5, and α is 0≤α≤2,
M and M′ are each independently selected from the group consisting of Mg, Al, Co, K, Na, Ca, Si, Ti, Sn, V, Ge, Ga, B, As, Zr, Mn, Cr, Fe, Sr, and V,
A is any one selected from the group consisting of O, F, S, and P, and X is any one selected from the group consisting of F, S, and P.

The separator may be a porous polymer film made of a polyolefin-based polymer such as an ethylene homopolymer, a propylene homopolymer, an ethylene/butene copolymer, an ethylene/hexene copolymer, or an ethylene/methacrylate copolymer, or may be a glass fiber nonwoven fabric or the like. In the case of a lithium metal battery, the electrolyte may include an electrolyte salt such as LiCl, LiBr, Lil, LiClO₄, LiBF₄, LiB₁₀Cl₁₀, LiB(Ph)₄, LiC₄BO₈, LiPF₆, LiCF₃SO₃, LiCF₃CO₂, LiAsF₆, LiSbF₆, LiAlCl₄, LiSO₃CH₃, LiSO₃CF₃, LiSCN, LiC(CF₃SO₂)₃, LiN(CF₃SO₂)₂, LiN(C₂F₅SO₂)₂, or LiN(SO₂F)₂, and preferably, a lithium imide such as LiTFSI may be used.

In addition, the present invention provides a device which is any one selected from the group consisting of a portable electronic device, a moving unit, a power device, and an energy storage device, the device including the secondary metal battery. Hereinafter, specific embodiments of the present invention will be described in detail by way of example.

### EXAMPLE

### Preparation Example 1: Preparation of Carbonized Material Containing Transition Metal Copper (c-Cu-CNF)

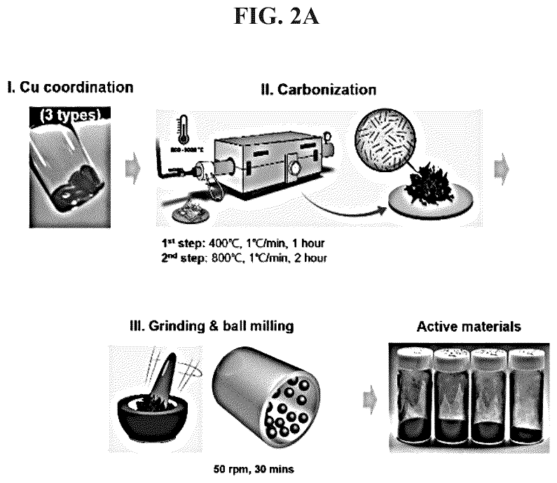

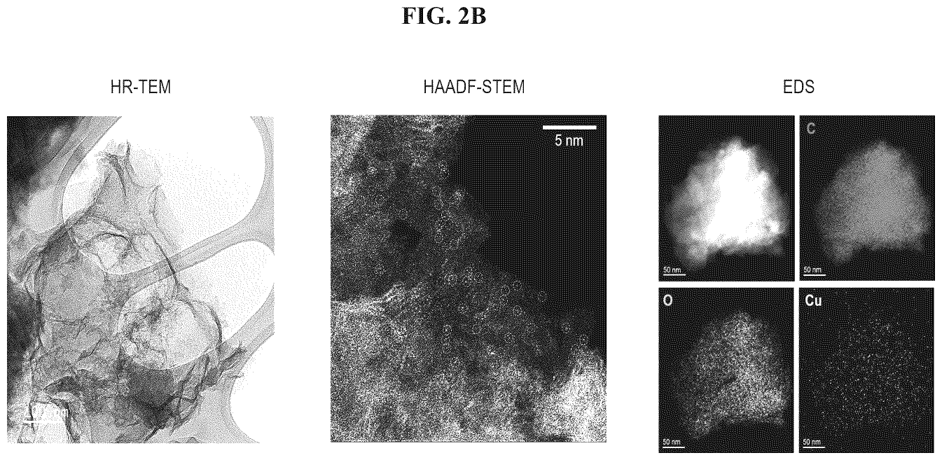

FIG. 2A is a process diagram showing the manufacturing process of a carbonized material containing copper (Cu). With reference to FIG. 2A, the method for preparing the carbonized material (c-Cu-CNF) containing the transition metal copper (Cu) will be described below.

0.0034 g of copper sulfate (CuSO₄) was added to a 20 wt % sodium hydroxide (NaOH) solution to prepare a copper ion solution in which Cu²⁺ ions are present in the liquid phase. Subsequently, 64 g of a suspension in which 2 wt % of cellulose material is dispersed in water was added to the copper ion solution, and stirred thoroughly for 2 days to induce a structural change in the crystalline structure of the molecular linear chains constituting the cellulose, as well as gradual coordination bonding between hydroxyl groups and Cu²⁺ ions. After that, the cellulose material coordinated with Cu²⁺ ions was precipitated twice each in water and ethanol using a centrifuge to separate it from remaining sodium hydroxide (NaOH), sulfate ions, and other components in the liquid phase. The resulting precursor material was subjected to a first carbonization by heating at a rate of 1° C. per minute to 400° C. and maintaining the temperature for 2 hours, and then a second carbonization was performed by maintaining the temperature at 800° C. for 1 hour. The carbonization process was carried out under an argon (Ar) atmosphere.

Meanwhile, a TEM image of the carbonized material (c-Cu-CNF) containing the transition metal copper (Cu) is shown in FIG. 2B. Referring to FIG. 2B, it can be confirmed that Cu exists within the carbonized material at a single-atom level or in the form of clusters composed of several atoms.

### Example 1: Preparation of Electrode Host

The carbonized material containing a transition metal, prepared according to Preparation Example 1, was ground and subjected to ball milling at 50 rpm for 30 minutes to obtain a powder of the carbonized material containing the transition metal (c-Cu-CNF).

A slurry for an electrode was prepared based on 1 g total weight by mixing, in a weight ratio of 96.5:0.5:3, a powder of the carbonized material containing a transition metal (c-Cu-CNF) as an active material, carbon black as a conductive material, and a binder composed of a 1:1 (w/w) mixture of carboxymethyl cellulose (CMC) and styrene-butadiene rubber (SBR). Subsequently, the slurry was cast onto a copper (Cu) current collector using a blade casting device, and after drying, an electrode host having a thickness of 50 μm was fabricated.

### Device Example 1: Fabrication of Half Cell

A half cell was fabricated by placing a 19 μm-thick polyethylene separator between a circular lithium metal (diameter: 8 mm) and the c-Cu-CNF electrode prepared according to Example 1 (with a diameter of 10 q), and using an electrolyte composed of 1 M LiTFSI in DOL/DME=(1/1, v/v) with 2 wt % LiNO₃.

### Device Example 2: Fabrication of Full Cell

A lithium secondary battery was fabricated under the same conditions as in Device Example 1, except that an LFP cathode (1.5 mAh/cm²) was used instead of lithium metal, and the c-Cu-CNF electrode of Example 1 was used as the anode.

### Device Example 3: Fabrication of Full Cell

A lithium secondary battery was fabricated under the same conditions as in Device Example 1, except that an LFP cathode (1.9 mAh/cm²) was used instead of lithium metal, and the c-Cu-CNF electrode of Example 1 was used as the anode.

### Comparative Device Example 1: Fabrication of Half Cell

A half cell was fabricated under the same conditions as in Device Example 1, except that a graphite electrode was used instead of the c-Cu-CNF electrode host of Example 1.

### Comparative Device Example 2: Fabrication of Full Cell

A lithium secondary battery was fabricated under the same conditions as in Device Example 2, except that a graphite electrode was used instead of the c-Cu-CNF electrode host of Example 1.

### Comparative Device Example 3: Fabrication of Full Cell

A lithium secondary battery was fabricated under the same conditions as in Device Example 3, except that a graphite electrode was used instead of the c-Cu-CNF electrode host of Example 1.

### Experimental Example

### Experimental Example 1: Analysis of Lithium Metal Electrodeposition on Anode Surface

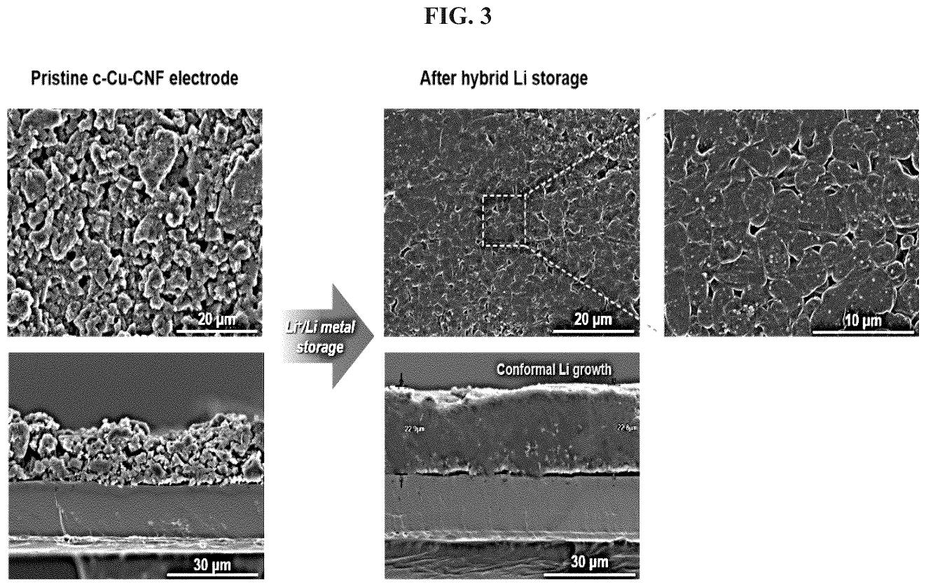

Lithium ion storage and lithium metal electrodeposition were induced on an electrochemically active electrode through electrochemical reactions. The intended electrodeposition capacity of lithium metal was 1 mAh/cm². An SEM image of the electrode surface after lithium metal deposition is shown in FIG. 3.

According to the results, it was confirmed that lithium metal was uniformly deposited on the surface of the c-Cu-CNF electrode of Example 1 without forming dendrites.

### Experimental Example 2: Charge-Discharge Profile Analysis

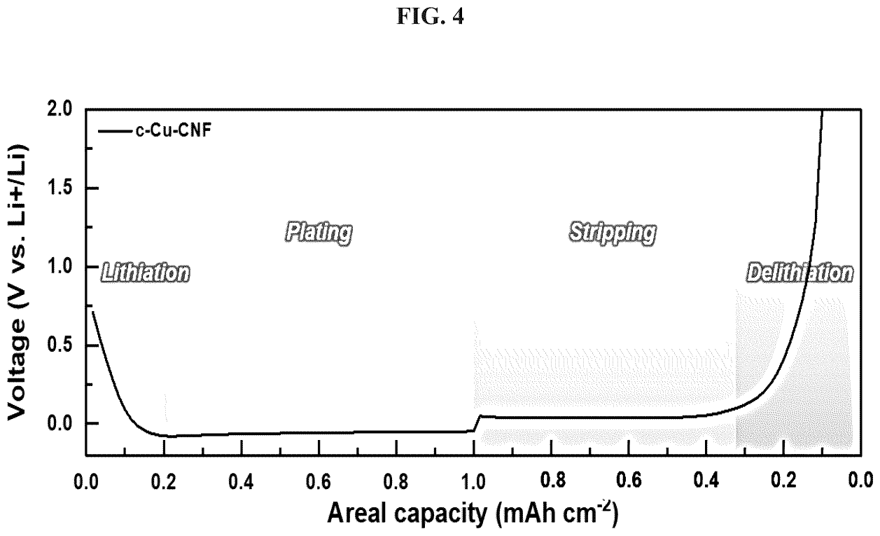

For the half cell including the c-Cu-CNF electrode prepared in accordance with Device Example 1, a constant current density corresponding to 1 mA/cm² was applied during discharge until the areal capacity reached 1 mAh/cm². Under the same current density, a charge was applied up to a voltage of 2 V, and charge-discharge testing was performed. The resulting voltage profile is shown in FIG. 4. According to the results, it was confirmed that the c-Cu-CNF electrode undergoes sequential and reversible reactions of lithiation, lithium metal deposition, lithium metal stripping, and delithiation.

### Experimental Example 3: Surface Composition Analysis of Electrode Host Used as Anode (XPS Analysis)

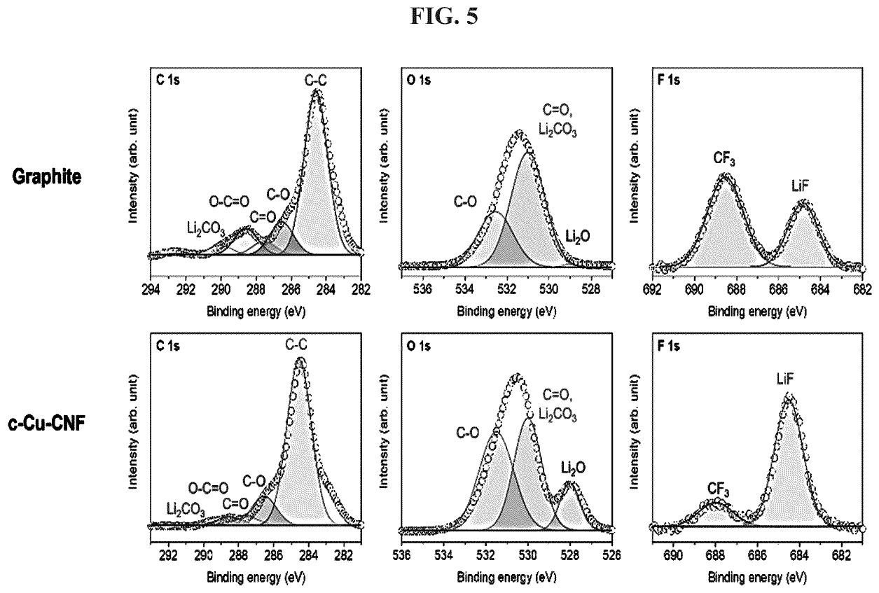

XPS (X-ray Photoelectron Spectroscopy) analysis was performed to analyze the surface composition of the anode after charge-discharge tests were conducted on the half cell of Device Example 1 using the c-Cu-CNF electrode host as the anode, and on the half cell of Comparative Device Example 1 using a graphite anode, at a current density of 0.1 mA/cm² within a voltage range of 0.01-2 V. The results of the analysis are shown in FIG. 5.

According to the results, it was confirmed that an SEI (Solid Electrolyte Interphase) layer rich in inorganic components was formed on the surface of the anode. In particular, a strong signal of lithium fluoride (LiF), which is known to facilitate uniform and smooth transport of lithium ions at the interface of lithium metal anodes, was clearly detected in the c-Cu-CNF electrode. Therefore, it can be inferred that the reductive decomposition of salt anions occurred more actively due to the catalytic effect of the c-Cu-CNF active material.

### Experimental Example 4: Cycle Performance Evaluation in Half Cell

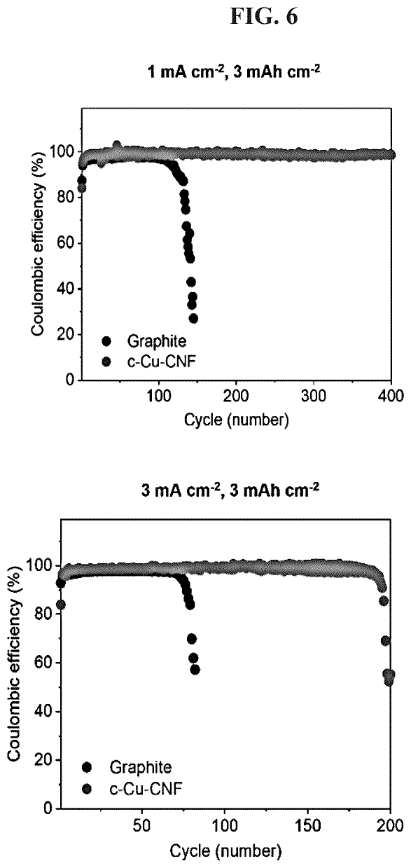

Cycle performance and Coulombic efficiency were evaluated for the half cell of Device Example 1, which used the c-Cu-CNF electrode host as the anode, and the half cell of Comparative Device Example 1, which used a graphite anode. The test was conducted under the same capacity condition (3 mAh/cm²) at current densities of 1 mA/cm² and 3 mA/cm², respectively. The results are shown in FIG. 6.

According to the results, it was confirmed that when the c-Cu-CNF electrode host was used as the anode, superior reversibility in lithium ion and lithium metal storage could be achieved compared to the graphite electrode. At the same capacity (3 mAh/cm²), superior reversibility was observed in the c-Cu-CNF electrode regardless of the current density, compared to the graphite electrode.

### Experimental Example 5: Cycle Performance Analysis in Full Cell

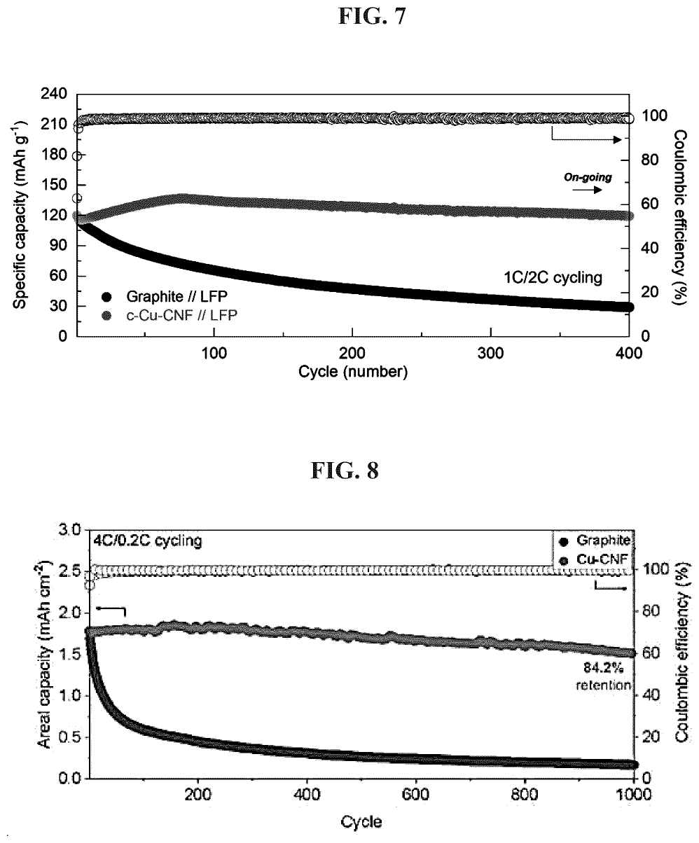

The cycle performance was analyzed under 1C/2C charge-discharge conditions for the full cell of Device Example 2 using the c-Cu-CNF electrode host as the anode, and the full cell of Comparative Device Example 2 using a graphite anode. The results are shown in FIG. 7.

According to the results, the full cell of Device Example 2 including the c-Cu-CNF anode exhibited a capacity retention rate close to 100% even after 400 cycles. This confirms that the lithium secondary battery using the carbonized metal structure containing transition metal copper (Cu) as the anode shows superior electrochemical performance compared to a conventional lithium secondary battery using a graphite anode.

### Experimental Example 6: Rate Capability Analysis in Full Cell

The rate capability was analyzed under 4C/0.2C charge-discharge conditions for the full cell of Device Example 3 using the c-Cu-CNF electrode host as the anode, and the full cell of Comparative Device Example 3 using a graphite anode. The results are shown in FIG. 8.

According to the results, the full cell of Device Example 3 including the c-Cu-CNF anode exhibited a capacity retention rate of approximately 84.2% even after 1,000 cycles. This confirms that the lithium secondary battery using the carbonized metal structure containing transition metal copper (Cu) as the anode has superior rate capability compared to a conventional lithium secondary battery using a graphite anode.

Although the embodiments of the present invention have been described above, it will be apparent to those skilled in the art that various modifications and changes can be made to the present invention without departing from the spirit of the invention as set forth in the claims, such as addition, alteration, deletion, or supplementation of components, and such modifications are also to be understood as falling within the scope of the present invention.

What is claimed is:

1. A metal storage host comprising:
a three-dimensional structure including a carbonized material; and
a transition metal distributed on the three-dimensional structure in a single-atom state, a cluster state of atoms, or a mixed state of the single-atom state and the atom cluster state.

2. The metal storage host according to claim 1,
wherein the carbonized material is a product resulting from carbonization of cellulose.

3. The metal storage host according to claim 1,
wherein the transition metal is at least one selected from the group consisting of copper (Cu), zinc (Zn), nickel (Ni), cobalt (Co), iron (Fe), manganese (Mn), chromium (Cr), vanadium (V), titanium (Ti), scandium (Sc), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

4. An anode of a secondary metal battery comprising the metal storage host according to claim 1.

5. The anode of a secondary metal battery according to claim 4,
wherein a metal, serving as an anode active material, is additionally electrodeposited on the metal host.

6. The anode of a secondary metal battery according to claim 5,
wherein the metal, serving as the anode active material, is any one selected from the group consisting of lithium (Li), sodium (Na), potassium (K), zinc (Zn), magnesium (Mg), and aluminum (Al).

7. A method for manufacturing a metal storage host, comprising:
(a) preparing a transition metal ion solution by introducing a transition metal salt into a strong base aqueous solution;
(b) preparing cellulose coordinated with transition metal ions by introducing cellulose into the transition metal ion solution and allowing it to react;
(c) carbonizing the cellulose coordinated with the transition metal ions to prepare a carbonized material including a transition metal distributed in a single-atom state, a cluster state of atoms, or a mixed state of the single-atom state and the atom cluster state;
(d) preparing an electrode host slurry by mixing the carbonized material containing the transition metal, a conductive material, and a binder; and
(e) coating the electrode host slurry on a current collector.

8. The method for manufacturing a metal storage host according to claim 7,
wherein the metal storage host is also used as an anode for a metal battery.

9. The method for manufacturing a metal storage host according to claim 8,
further comprising a step of electrochemically electrodepositing a metal, which serves as an anode active material of a secondary metal battery, on the metal storage host.

10. The method for manufacturing a metal storage host according to claim 7,
wherein, in step (a), the transition metal salt is a sulfate or nitrate of a transition metal.

11. The method for manufacturing a metal storage host according to claim 7,
wherein, in step (b), the cellulose is at least one selected from the group consisting of cellulose nanofibers (CNF) and cellulose nanocrystal (CNC).

12. The method for manufacturing a metal storage host according to claim 11,
wherein the cellulose nanofibers have a diameter of 1 nm to 100 μm and a length of 50 nm to 500 μm, and the cellulose nanocrystals have a diameter of 1 nm to 100 μm.

13. The method for manufacturing a metal storage host according to claim 7,
wherein, in step (c), the carbonization is performed at a temperature of 300 to 1000° C.

14. The method for manufacturing a metal storage host according to claim 13,
wherein the carbonization is performed by carrying out a first carbonization at 300 to 600° C., followed by a second carbonization at 700 to 1000° C.

15. The method for manufacturing a metal storage host according to claim 7,
wherein, in step (c), the carbonization is performed under an inert gas atmosphere.

16. The method for manufacturing a metal storage host according to claim 7,
wherein, in step (d), the electrode slurry comprises 0.5 to 1 part by weight of a conductive material and 3 to 5 parts by weight of a binder, based on 100 parts by weight of the carbonized material containing the transition metal.

17. The method for manufacturing a metal storage host according to claim 7,
wherein, in step (e), the coating is performed by any one selected from the group consisting of slurry casting, spray coating, filtration process, dry process, sputtering coating, electroless plating, electrostatic spraying (E-spraying), vapor deposition, inkjet printing, imprint lithography, offset printing, and 3D printing.

18. A secondary metal battery comprising the metal storage host according claim 1.
